(19) United States
(12) Patent Application Publication
(10) Pub. No.: US 2012/0027081 A1
(43) Pub. Date: Feb. 2, 2012

(54) METHOD, SYSTEM, AND COMPUTER READABLE MEDIUM FOR IMPLEMENTING RUN-LEVEL CODING

(75) Inventors: Lars Petter Endresen, Nesoddtangen (NO); Stian Selnes, Oslo (NO)

(73) Assignee: Cisco Technology Inc., San Jose, CA (US)

(21) Appl. No.: 13/194,183

(22) Filed: Jul. 29, 2011

Related U.S. Application Data
(60) Provisional application No. 61/369,290, filed on Jul. 30, 2010.

(30) Foreign Application Priority Data
Jul. 30, 2010 (NO) 20101088

(51) Int. Cl. H04N 7/30

(52) U.S. Cl. 375/240.03; 375/E07.232

(57) ABSTRACT

A method for representing transform coefficients in compression/decompression of digital video systems in multi-purpose processors. Exemplary embodiments of the method may significantly reduce the required processor capacity compared to conventional methods.

### CROSS-REFERENCE TO RELATED APPLICATIONS

The present application claims the benefit of provisional application No. 61/369,290, filed Jul. 30, 2010, the entire contents of which are hereby incorporated herein by reference. The present application also claims the benefit of priority under 35 U.S.C. §119 to Norwegian patent application no. NO20101088, filed Jul. 30, 2011, the entire contents of which are hereby incorporated by reference.

### TECHNOLOGICAL FIELD

The exemplary embodiments discussed herein relate to implementation of entropy coding/decoding of transform coefficient data of video compression systems in computer devices.

### BACKGROUND

Transmission of moving pictures in real-time is employed in several applications including, but not limited to, video conferencing, net meetings, TV broadcasting and video telephony.

However, representing moving pictures requires bulk information as digital video typically is described by representing each pixel in a picture with 8 bits (1 Byte). Such uncompressed video data results in large bit volumes, and cannot be transferred over conventional communication networks and transmission lines in real time due to limited bandwidth.

Thus, enabling real time video transmission requires a large extent of data compression. Data compression may, however, compromise the picture quality. Therefore, great efforts have been made to develop compression techniques allowing real time transmission of high quality video over bandwidth limited data connections.

The most common video coding method is described in the MPEG* and H.26* standards. The video data undergo four main processes before transmission, namely prediction, transformation, quantization and entropy coding.

The prediction process significantly reduces the amount of bits required for each picture in a video sequence to be transferred. It takes advantage of the similarity of parts of the sequence with other parts of the sequence. Since the predictor part is known to both the encoder and the decoder, only the difference has to be transferred. This difference typically requires much less capacity for its representation. The prediction is mainly based on vectors representing movements. The prediction process is typically performed on square block sizes (e.g. 16×16 pixels). Note that in some cases, predictions of pixels based on the adjacent pixels in the same picture rather than pixels of preceding pictures are used. This is referred to as intra prediction, as opposed to inter prediction.

The residual represented as a block of data (e.g. 4×4 pixels) still contains internal correlation. A well-known method of taking advantage of this is to perform a two dimensional block transform. In H.263, an 8×8 Discrete Cosine Transform (DCT) is used, whereas H.264 uses a 4×4 integer type transform. This transforms 4×4 pixels into 4×4 transform coefficients and they can usually be represented by fewer bits than the pixel representation. Transform of a 4×4 array of pixels with internal correlation will probably result in a 4×4 block of transform coefficients with much fewer non-zero values than the original 4×4 pixel block. Direct representation of the transform coefficients is still too costly for many applications. A quantization process is carried out for a further reduction of the data representation. Hence the transform coefficients undergo quantization. A simple version of quantisation is to divide parameter values by a number—resulting in a smaller number that may be represented by fewer bits. It should be mentioned that this quantization process has as a result that the reconstructed video sequence is somewhat different from the uncompressed sequence. This phenomenon is referred to as “lossy coding”. The outcome from the quantization part is referred to as quantized transform coefficients.

Entropy coding is a special form of lossless data compression. It involves, for example, arranging the image components in a “zigzag” order employing a run-length encoding (RLE) algorithm that groups similar frequencies together, inserting length coding zeros, and then using Huffman coding on what is left.

In H.264 encoding, the DCT coefficients for a block are reordered to group together non-zero coefficients in an array, enabling efficient representation of the remaining zero-valued coefficients. The zigzag reordering path (scan order) is shown in FIG. 1. The pattern of the order of n the zig-zag scan is configured according to the probability of non-zero coefficients in each position. Due to the characteristics of the preceding DCT, the probability of non-zero coefficients in a block decreases the downward right diagonal direction of a DCT block. When reordering the coefficients in a zigzag pattern as illustrated in FIG. 1, the non-zero coefficients will tend to concentrate in the first positions of the array.

The output of the reordering process is, for example, a one dimensional array that typically contains one or more clusters of nonzero coefficients near the start, followed by strings of zero coefficients. Due to the large number of zero values, the array is further represented as a series of (run, level) pairs where run indicate the number of zeros preceding a nonzero coefficient, and level indicates the magnitude of the nonzero coefficient. As an example, the input array 16, 0, 0, −3, 5, 6, 0, 0, 0, 0, −7, . . . will have the following corresponding run-level values (0,16), (2,−3), (0,5), (0,6), (4,−7) . . . .

When transforming the zigzag array to run-level values, it is computationally expensive to loop over all coefficients and check whether they are non-zero. As the picture resolution increases, this will require a considerable amount of processor capacity an even introduce too much delay, especially if the encoding process is implemented on general purpose shared processors, e.g. on personal computers.

Norwegian patent application 20090715, the entire content of which is hereby incorporated by reference, describes an implementation of a process for representing transform coefficients in compression/decompression of digital video systems in multi-purpose processors. Quantized transform coefficients representing a block of pixels in a video picture are packed to half the memory size, and then masked so as to generate an array of 1's and 0's defining the positions of non-zero coefficients in the corresponding array of packed transform coefficients. This preparation avoids parsing through positions in the array of transform coefficients were zero values occur when generating run-level representations of the coefficients, thus significantly reducing the required number of loops to execute. However, this method requires that a certain shuffle function reordering data entries in the memory to any order is available as a hard coded process in the processor. This function may be available in new generation Intel processors.

### SUMMARY OF THE INVENTION

A method including: obtaining, by an encoding or decoding apparatus, quantized transform coefficients representing pixel values in a block of a video picture, which are processed row by row in a one dimensional array C; packing, by the encoding or decoding apparatus, each of the quantized transform coefficients in the array C in a value interval ranging from a maximum value to a minimum value by setting all the quantized transform coefficients greater than the maximum value equal to the maximum value, and all quantized transform coefficients less than the minimum value equal to the minimum value; masking, by the encoding or decoding apparatus, the array C as modified by the packing, by generating an array M containing 1's in positions corresponding to positions of the array C as modified by the packing having non-zero values, and 0's in positions corresponding to positions of the array C as modified by the packing having zero values; setting a current raster position to zero, where a raster position is a raster scan order of the quantized transform coefficients in the block; and for each position containing a 1 in the array M, deriving a current zigzag position from a current raster position through a table mapping raster positions to zigzag positions, where a zigzag position is a zigzag scan order of the quantized transform coefficients in the block, if the current zigzag position is not zero and if the current zigzag position minus a last zigzag position minus 1 is less than zero, then discarding all stored runs and levels and calculating new runs and levels with an alternative fall back method, if not, setting a run equal to the current zigzag position minus the last zigzag position minus 1 and a level equal to an occurring value in the position of the array C corresponding to the current raster position, storing the run and the level, setting the last zigzag position equal to current zigzag position, and incrementing current raster position with a number of positions to the next 1 in the array M.

An apparatus including: memory that stores computer executable instructions; and a processor that executes the computer executable instructions in order to obtain quantized transform coefficients representing pixel values in a block of a video picture, which are processed row by row in a one dimensional array C, pack each of the quantized transform coefficients in the array C in a value interval ranging from a maximum value to a minimum value by setting all the quantized transform coefficients greater than the maximum value equal to the maximum value, and all quantized transform coefficients less than the minimum value equal to the minimum value, mask the array C as modified by the packing, by generating an array M containing 1's in positions corresponding to positions of the array C as modified by the packing having non-zero values, and 0's in positions corresponding to positions of the array C as modified by the packing having zero values, set a current raster position to zero, where a raster position is a raster scan order of the quantized transform coefficients in the block, and for each position containing a 1 in the array M, derive a current zigzag position from a current raster position through a table mapping raster positions to zigzag positions, where a zigzag position is a zigzag scan order of the quantized transform coefficients in the block, if the current zigzag position is not zero and if the current zigzag position minus a last zigzag position minus 1 is less than zero, then discard all stored runs and levels and calculating new runs and levels with an alternative fall back method, if not, set a run equal to the current zigzag position minus the last zigzag position minus 1 and a level equal to an occurring value in the position of the array C corresponding to the current raster position, store the run and the level, set the last zigzag position equal to current zigzag position, and increment current raster position with a number of positions to the next 1 in the array M.

### BRIEF DESCRIPTION OF THE DRAWINGS

In order to make the exemplary embodiments described herein more readily understandable, the discussion that follows will refer to the accompanying drawings and tables.

FIG. 1 illustrates a conventional zigzag pattern that is used to transform coefficients before entropy coding;

FIG. 2 illustrates the raster scan pattern that is used in an exemplary embodiment;

FIG. 3 is an exemplary flow chart illustrating how a run-level code is calculated;

FIG. 4 is a flow chart illustrating a method that makes it possible to efficiently jump over all the zero valued coefficients;

FIG. 5 is a flow chart illustrating a method for implementing run-level coding; and

FIG. 6 is an exemplary computer system which may execute the methods described herein.

### DETAILED DESCRIPTION OF THE PRESENT INVENTION

In the following description, reference will be made to some standard functions in the library of the general purpose programming language C++ that are directly mapped to compact and efficient low-level CPU instructions. C++ is widely used in the software industry. Some of its application domains include systems software, device drivers, embedded software, high-performance server and client applications, and entertainment software as well as for implementing coding and decoding of real-time video in general purpose computers.

In video compression systems, the main goal is to represent the video information with as little capacity as possible. Capacity is defined with bits, either as a constant value or as bits/time unit. In both cases, the main goal is to reduce the number of bits.

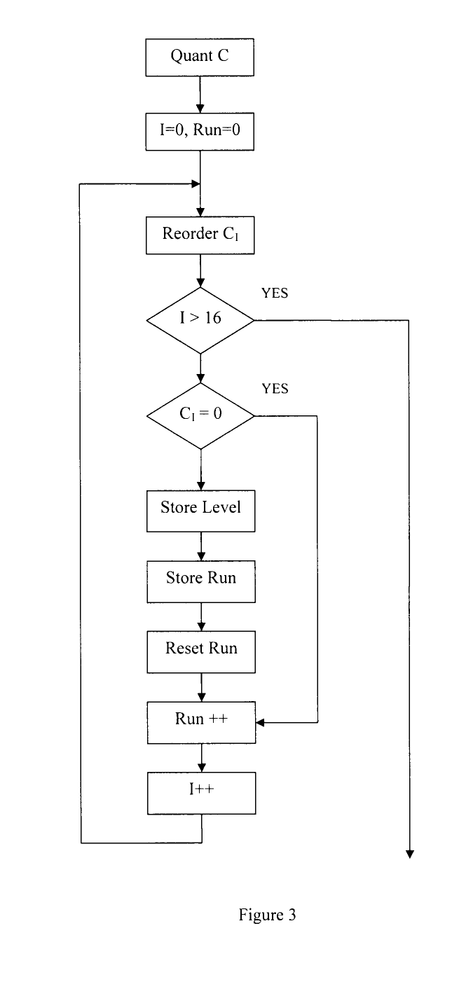

FIG. 3 is a flow chart illustrating how the run-level code according to MPEG4 and H.264 is calculated in a first implementation. After quantizing the transform coefficients (Quant C) in a block, the quantized coefficients are reordered to a one dimensional array according to the earlier mentioned zigzag pattern (FIG. 1). The process then enters into a loop for parsing the array for determining the run-level values. First it is checked whether the number of positions in the array is exceeded (I>16). If not, it is then checked whether current position in the array contains a zero. If so, both the Run variable and the position index (I) is incremented, and the process proceeds to the start of the loop again. If not (current position contains a non-zero value), the current Run variable and the value of the current position is stored as the Run-Level value. The Run variable is then reset, before both the Run variable and the position index (I) are incremented and the process is proceeding to the start of the loop again. The process ends whenever the position index exceeds the maximum size of the array, which in the example illustrated in FIG. 3 is 16.

As can be seen from the example illustrated in FIG. 3, it always has to run through the run-level encoding loop as many times as there are positions in the array (16 times in the examples). This becomes very inefficient as most coefficients in C are zero, and it is computationally expensive to loop over all coefficients and check whether they are non-zero.

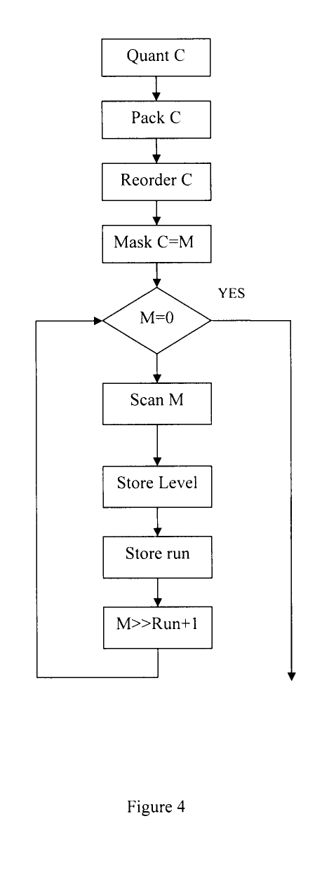

FIG. 4 is a flow chart illustrating a second implementation according to the above-mentioned method disclosed in Norwegian patent application 20090715. In this implementation, bit-masks and bit-scan instructions which makes it possible to efficiently jump over all the zero valued coefficients is used. It starts by quantizing the transform coefficients in the block. In the example, there are 16 coefficients that are stored in the vector C.

The process then proceeds by packing all the quantized coefficients. This is done by the C++ instruction PACKUSWB, which transforms 16 signed words to unsigned integers and saturates. This means that if a coefficient is larger or smaller than the range of an unsigned byte, the coefficient is set to respectively max or min value of the range, which in this implementation is 255 and 0. In this way, the memory size of each coefficient is reduced from 2 to one byte.

The next step is to mask the quantized, packed and reordered coefficients. This is done by, for example, applying the C++ functions PCMPGTB and PMOVMSKB. The PCMPGTB function fills a whole byte of 1'es in the position of non-zero values, and leave the 0'es unchanged in the position of zeros. The PMOVMSKB function creates a 16-bit mask from the most significant bits of 16 bytes. The result of these two functions when applied on the array of quantized, packed and reordered coefficients (C) is a 16-bit array (M) where the 1'es indicates the corresponding positions of the non-zero values of C.

If M is nonzero, the C++ function BSF can be used to calculate the index of the first nonzero value of C. BSF returns the bit index of the least significant bit of an integer, i.e. in the case of M, the first position of a 1 starting from the right-hand side.

Hence, this index returned by BSF when applied on M is equal to the run and is used directly as lookup in the C array to determine the level. This is possible since C is already shuffled using PSHUFB instruction.

The Run-value as indicated by the BSF function is then stored, and after looking up the value localized at that position in the C is stored as the level value.

M is finally shifted to the right run+1 times to clear the index bit from M and prepare M for the next iteration in the loop. By doing this, the content of M corresponding to Run-Level values already calculated is removed from M, and the loop can be applied in the same way to calculate the reminding Run-Level values.

Since all the zeroes are being jumped over by using the BSF instruction, only nonzero coefficients runs are required to calculate all level and run values.

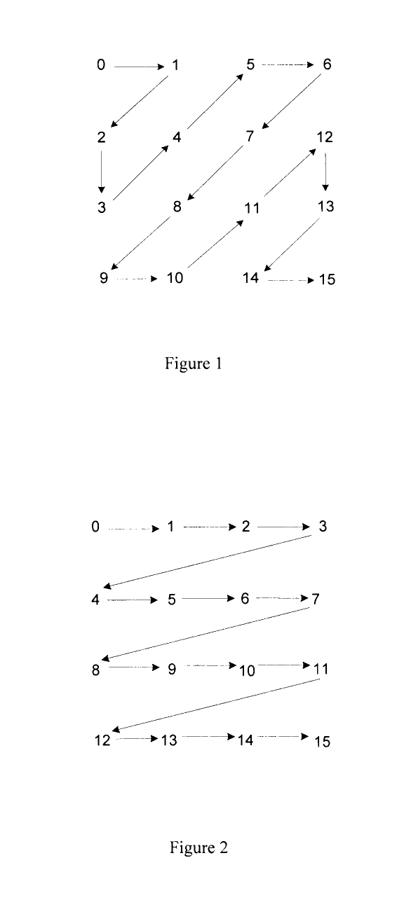

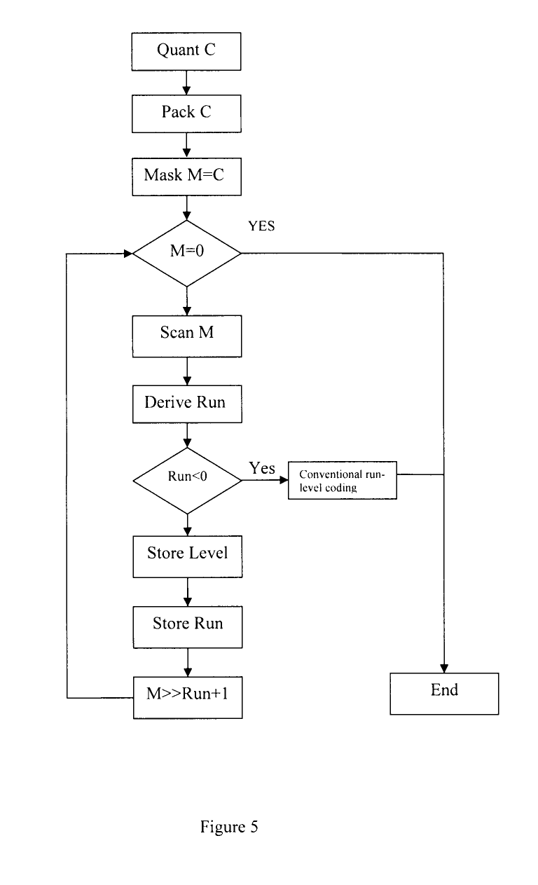

Another embodiment discussed below is based on the observation that in practice, runs of zero coefficients in the 4×4 raster scan order illustrated in FIG. 2 are often equivalent to runs in the 4×4 zig-zag order illustrated in FIG. 1. In the cases where a criterion for this conversion is fulfilled a first method is used (an example of which is shown in FIG. 5), and in cases where a criterion for this conversion is not fulfilled a fallback method, FIG. 3 for example, is used. The effect is that in most cases zig-zag scanning (FIG. 1) is not performed, but only the more effective raster scan (FIG. 2) and a run-conversion for the non-zero coefficients is performed.

The run-conversion is valid for all cases where the non-zero coefficients appear in the same order for both scans. In theory this is not the most probable case considering all possible permutations, but in practice it is. Measurements done by the inventors have shown that non-zero coefficients appear in the same order for both scans in 98.5% of the coding time.

If coefficients with raster scan index 0, 1, 4 and 5 are non-zero, then both scans will return the four coefficients in the same order, but with different runs. The raster scan runs can then be converted to the equivalent zigzag run. As can be seen from FIGS. 1 and 2, the following mapping between the raster scan positions and the zigzag scan position applies: 0-0, 1-1, 2-5, 3-6, 4-2, 5-4, 6-7, 7-12, 8-3, 9-8, 10-11, 11-13, 12-9, 13-10, 14-14, 15-15. In the example above, when the runs for a raster scan indicates non-zeros for scan index 0, 1, 4 and 5, this mapping will imply 0, 1, 2 and 4 as the corresponding zig-zag scan index. Hence, when the order of non-zeros are the same for is raster scan and zig-zag scan, the second and the most effective method described above (FIG. 3 or 4) can be used, but there is no need to reorder the coefficients, and the shuffle function can be omitted.

Contrary, if for example the raster scan indexes 0, 2 and 4 are non-zero, the order of appearance will be different for the two scans, and since the shuffle function is not available as a fallback method, the method of FIG. 3 must be used.

The criterion to trigger the fallback is to test whether a calculated run for the raster scan order yields a negative result.

The run calculation is performed by measuring whether one or more run value in raster scan order is negative when using corresponding zigzag scan index in the calculation. For example, the current raster scan index is derived and mapped to the corresponding zigzag index, using a normal zigzag table as defined in the H.264 recommendation. The calculation is described in detail in the following.

Let xₖ denote the zigzag position of the nonzero coefficients wherein k indexes the occurrence of nonzero coefficients. Further, let Rₖ denote the run value for the k'th occurrence of a nonzero value in a zigzag scan order, R′ₖ being the run value of the k'th occurrence of a nonzero value in raster scan order when using zigzag scan index in the calculation. N is the last k index so that N+1 is the total number of nonzeros. A run value for a nonzero coefficient position xₖ can be calculated as xₖ−xₖ₋₁−1. For the zigzag scan order, this is always a positive value since,

x_{N}>x_{N-1}> . . . >x₁>x₀ (1)

The total run R_{T} for N+1 runs is,

$$\begin{matrix}{R}_{T} = {R}_{0} + {R}_{1} + {R}_{2} + … + {R}_{N} \\ = {x}_{0} + ( {x}_{1} - {x}_{0} - 1 ) + ( {x}_{2} - {x}_{1} - 1 ) + … + \\ ( {x}_{N} - {x}_{N - 1} - 1 ) \\ = {x}_{N} - N .\end{matrix} \qquad ( 2 )$$

In general, however, the raster scan order of the nonzero coefficients may differ from the zigzag scan order. When using the zigzag positions xₖ in the calculation for the corresponding raster positions, this will always lead to at least one negative raster scan run, since any permutation of the positions in (1) will violate (1). Imagine, for example, three nonzero coefficients and that the zigzag order returns x₀, x₁, x₂, while the raster scan returns x₀, x₂, x₁. The total run for the two cases then becomes

Zig-zag: R_{T}=R₀+R₁+R₂=x₀+(x₁−x₀−1)+(x₂−x₁−1)=x₂−2 (3)

Raster: R′_{T}=R′₀+R′₁+R′₂=x₀+(x₂−x₀−1)+(x₁−x₂−1)=x₁−2 (4)

The last run R′₂ in (4) is negative since x₁<x₂. Hence, the criterion for the fallback method is triggered.

FIG. 5 is a flow chart illustrating an example of run-level coding. This method does not have to include reordering data, since the data is processed in the raster scan order which is the same order as the data already is stored in the memory.

In “Quant C” the transformed coefficients of a 4×4 block C is quantized. C is simply a one dimensional data array where the coefficients are inserted consecutively row by row starting from the upper row of the block. The coefficients are thereby arranged in a raster scan order. “Mask M=C” creates a 16 bit mask M from the packet coefficients C where a 1-bit indicates a non-zero coefficient. In the decision box “M=0” the procedure is exited when there is no more non-zero coefficients left to process. “Scan M” scans the mask M in order to find the raster run R′ₖ. In “Derive Run” run Rₖ is derived from R′ₖ via raster index calculation and zigzag table lookup. In decision box “Run<0”, it is decided whether to fall back to a conventional run-level coding according to FIG. 1 as described above, ignoring the previously stored runs and levels, or to proceed by storing current level and run and then looping back to decision box “M=1”. The decision to fall back is made if a negative run Rₖ is detected.

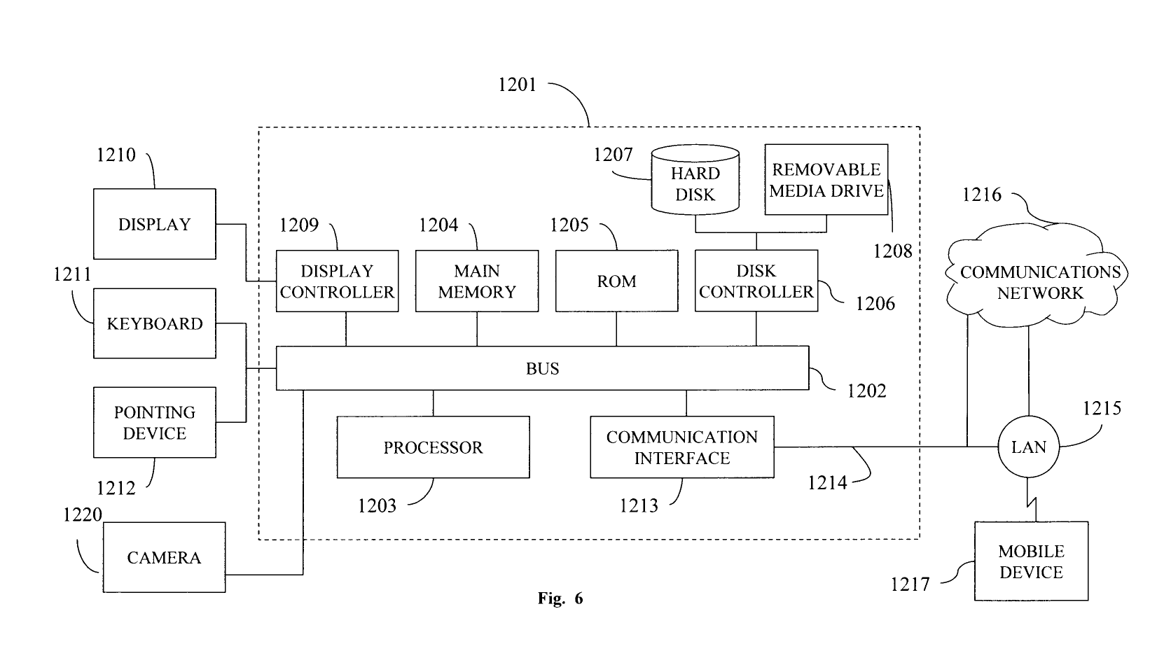

FIG. 6 illustrates a computer system 1201 upon which an embodiment of the encoding device or decoding device may be implemented.

The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210.

The computer system 1201 performs a portion or all of the processing steps in response to the processor 1203 executing one or more sequences of one or more instructions contained in a memory, such as the main memory 1204. Such instructions may be read into the main memory 1204 from another non-transitory computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions.

As stated above, the computer system 1201 includes at least one non-transitory computer readable medium or memory for holding instructions programmed according to the teachings of the exemplary embodiments discussed herein and for containing data structures, tables, records, or other data described herein. Examples of non-transitory computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium.

Stored on any one or on a combination of non-transitory computer readable media, exemplary embodiments include software for controlling the computer system 1201, for driving a device or devices for implementing functionality discussed herein, and for enabling the computer system 1201 to interact with a human user. Such software may include, but is not limited to, device drivers, operating systems, development tools, and applications software.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As is another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

While certain embodiments have been described, these embodiments have been presented by way of example only, and are not intended to limit the scope of the inventions. Indeed, the methods and systems described herein may be embodied in a variety of other forms. Elements from the various embodiments described herein may be combined together. Different embodiments do not mean that elements are not combinable or useable together. Furthermore, various changes in the form of the methods and systems described herein may be made without departing from the spirit of the inventions. The accompanying claims and their equivalents are intended to cover such forms or modifications as would fall within the scope and spirit of the inventions.

1. A method comprising:
obtaining, by an encoding or decoding apparatus, quantized transform coefficients representing pixel values in a block of a video picture, which are processed row by row in a one dimensional array C;
packing, by the encoding or decoding apparatus, each of the quantized transform coefficients in the array C in a value interval ranging from a maximum value to a minimum value by setting all the quantized transform coefficients greater than the maximum value equal to the maximum value, and all quantized transform coefficients less than the minimum value equal to the minimum value;
masking, by the encoding or decoding apparatus, the array C as modified by the packing, by generating an array M containing 1's in positions corresponding to positions of the array C as modified by the packing having non-zero values, and 0's in positions corresponding to positions of the array C as modified by the packing having zero values;
setting a current raster position to zero, where a raster position is a raster scan order of the quantized transform coefficients in the block; and
for each position containing a 1 in the array M,
deriving a current zigzag position from a current raster position through a table mapping raster positions to zigzag positions, where a zigzag position is a zigzag scan order of the quantized transform coefficients in the block,
if the current zigzag position is not zero and if the current zigzag position minus a last zigzag position minus 1 is less than zero, then
discarding all stored runs and levels and calculating new runs and levels with an alternative fall back method,
if not,
setting a run equal to the current zigzag position minus the last zigzag position minus 1 and a level equal to an occurring value in the position of the array C corresponding to the current raster position,
storing the run and the level,
setting the last zigzag position equal to current zigzag position, and
incrementing current raster position with a number of positions to the next 1 in the array M.

2. The method according to claim 1, wherein the table mapping raster positions to zigzag positions has the following entries: 0-0, 1-1, 2-5, 3-6, 4-2, 5-4, 6-7, 7-12, 8-3, 9-8, 10-11, 11-13, 12-9, 13-10, 14-14, 15-15.

3. The method according to claim 1, wherein the step of masking further comprises:
creating an array C′ from the array C as modified by the packing where positions corresponding to positions of non-zero values in the array C as modified by the packing C are filled with 1's and positions corresponding to positions of zero values in the array C as modified by the packing C are filled with 0's, and
generating the array M from C′ by extracting most significant bits from values in respective position of the array C′ and inserting the most significant bits in corresponding positions in the array M.

4. The method according to claim 3, wherein the step of creating the array C′ is executed by a C++ function PCMPGTB, and the step of generating the array M from the array C′ is executed by a C++ function PMOVMSKB.

5. The method according to claim 4, further comprising determining positions containing non-zero values in the array C as modified by the packing by executing C++ function BSF.

6. The method according to claim 1, wherein the maximum value is 256 and the minimum value is 0.

7. The method according to claim 1, wherein the zigzag scan order follows a zigzag path of transform coefficient positions in the block starting in upper left corner heading towards lower right corner, and the raster scan order follows a raster path of transform coefficient positions in the block starting in upper left corner running through coefficient positions from left to right row by row ending in the lower right corner.

8. A non-transitory computer readable storage medium encoded with instructions, which when executed by a computer causes the computer to implement a method comprising:
obtaining quantized transform coefficients representing pixel values in a block of a video picture, which are processed row by row in a one dimensional array C;
packing each of the quantized transform coefficients in the array C in a value interval ranging from a maximum value to a minimum value by setting all the quantized transform coefficients greater than the maximum value equal to the maximum value, and all quantized transform coefficients less than the minimum value equal to the minimum value;
masking the array C as modified by the packing, by generating an array M containing 1's in positions corresponding to positions of the array C as modified by the packing having non-zero values, and 0's in positions corresponding to positions of the array C as modified by the packing having zero values;
setting a current raster position to zero, where a raster position is a raster scan order of the quantized transform coefficients in the block; and
for each position containing a 1 in the array M,
deriving a current zigzag position from a current raster position through a table mapping raster positions to zigzag positions, where a zigzag position is a zigzag scan order of the quantized transform coefficients in the block,
if the current zigzag position is not zero and if the current zigzag position minus a last zigzag position minus 1 is less than zero, then
discarding all stored runs and levels and calculating new runs and levels with an alternative fall back method,
if not,
setting a run equal to the current zigzag position minus the last zigzag position minus 1 and a level equal to an occurring value in the position of the array C corresponding to the current raster position,
storing the run and the level,
setting the last zigzag position equal to current zigzag position, and
incrementing current raster position with a number of positions to the next 1 in the array M.

9. The non-transitory computer readable medium according to claim 8, wherein the table mapping raster positions to zigzag positions has the following entries: 0-0, 1-1, 2-5, 3-6, 4-2, 5-4, 6-7, 7-12, 8-3, 9-8, 10-11, 11-13, 12-9, 13-10, 14-14, 15-15.

10. The non-transitory computer readable medium according to claim 8, wherein the step of masking further comprises:
creating an array C′ from the array C as modified by the packing where positions corresponding to positions of non-zero values in the array C as modified by the packing C are filled with 1's and positions corresponding to positions of zero values in the array C as modified by the packing C are filled with 0's, and
generating the array M from C′ by extracting most significant bits from values in respective position of the array C′ and inserting the most significant bits in corresponding positions in the array M.

11. The non-transitory computer readable medium according to claim 10, wherein the step of creating the array C′ is executed by a C++ function PCMPGTB, and the step of generating the array M from the array C′ is executed by a C++ function PMOVMSKB.

12. The non-transitory computer readable medium according to claim 11, wherein the method further comprises determining positions containing non-zero values in the array C as modified by the packing by executing C++ function BSF.

13. The non-transitory computer readable medium according to claim 8, wherein the maximum value is 256 and the minimum value is 0.

14. The non-transitory computer readable medium according to claim 8, wherein the zigzag scan order follows a zigzag path of transform coefficient positions in the block starting in upper left corner heading towards lower right corner, and the raster scan order follows a raster path of transform coefficient positions in the block starting in upper left corner running through coefficient positions from left to right row by row ending in the lower right corner.

15. An apparatus comprising:
memory that stores computer executable instructions; and
a processor that executes the computer executable instructions in order to
obtain quantized transform coefficients representing pixel values in a block of a video picture, which are processed row by row in a one dimensional array C,
pack each of the quantized transform coefficients in the array C in a value interval ranging from a maximum value to a minimum value by setting all the quantized transform coefficients greater than the maximum value equal to the maximum value, and all quantized transform coefficients less than the minimum value equal to the minimum value,
mask the array C as modified by the packing, by generating an array M containing 1's in positions corresponding to positions of the array C as modified by the packing having non-zero values, and 0's in positions corresponding to positions of the array C as modified by the packing having zero values,
set a current raster position to zero, where a raster position is a raster scan order of the quantized transform coefficients in the block, and
for each position containing a 1 in the array M,
derive a current zigzag position from a current raster position through a table mapping raster positions to zigzag positions, where a zigzag position is a zigzag scan order of the quantized transform coefficients in the block,
if the current zigzag position is not zero and if the current zigzag position minus a last zigzag position minus 1 is less than zero, then
discard all stored runs and levels and calculating new runs and levels with an alternative fall back method,
if not,
set a run equal to the current zigzag position minus the last zigzag position minus 1 and a level equal to an occurring value in the position of the array C corresponding to the current raster position,
store the run and the level,
set the last zigzag position equal to current zigzag position, and
increment current raster position with a number of positions to the next 1 in the array M.
